(19) United States
(12) Patent Application Publication
(10) Pub. No.: US 2008/0295085 A1
(43) Pub. Date: Nov. 27, 2008

(54) INTEGRATED CODE REVIEW TOOL

(75) Inventors: Raghavendra Rachamadugu, Hyderabad (IN); Perraju Bendapudi, Hyderabad (IN); Manoj Jain, Hyderabad (IN)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/754,231

(22) Filed: May 25, 2007

(51) Int. Cl. G06F 9/45

(52) U.S. Cl. 717/159

(57) ABSTRACT

A code review tool system includes a developer on a developer node, a reviewer on a reviewer node, and a server on a server node. The developer node and the reviewer node include an integrated code review tool. The integrated code review tool includes functionality for a developer to specify source code files to be reviewed and a list of reviewer identifiers. The integrated code review tool also includes functionality to associate the reviewer's comments and/or proposed code changes with context information identifying a location in the source code files. The reviewer's comments, proposed code changes, and associated context information is sent to the developer. The developer may then see the reviewer's comments and proposed code changes in context with the location in the source code to which the comments and code changes pertain.

### BACKGROUND

Computer software is typically created by compiling, or translating, human readable source code written in a programming language such as C++ or C# into computer-executable instructions such as machine code, or, in the case of dynamic runtime environment, intermediate code. A developer typically creates source code using an integrated development environment (IDE), however, a developer may use any type of text editor. As part of the development process, a developer may request that another software developer or tester perform a review of the source code the developer has written. Such a code review may be a substantive examination of the source code to find mistakes, deviations from accepted coding practices, and the like. A developer typically indicates to the reviewer which source code files are to be reviewed. The reviewer examines the changes in the source code files and makes any comments regarding the changes. The reviewer may also make changes to the source code files if necessary. The reviewer then returns the comments and, optionally, the source code to the developer.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides an integrated code review application and associated methods for execution within a code review tool system. The integrated code review tool includes functionality for a reviewer to make comments and/or propose source code changes to source code files under review. The integrated code review tool also includes functionality to associate context information, such as a source code file name, a source code function name, a source code line number, and the like, with comments and/or proposed source code changes.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows an example of a computing device for implementing one or more embodiments of an integrated code review tool system.

FIG. 2 shows an example system for implementing one or more embodiments of an integrated code review tool system.

FIG. 3 shows an example of a developer node included in one or more embodiments of an integrated code review tool system.

FIG. 4 shows an example of a reviewer node included in one or more embodiments of an integrated code review tool system.

FIG. 5 shows an example of a server node included in one or more embodiments of an integrated code review tool system.

FIG. 6 shows a flow diagram of an example code review method for performance by an integrated code review system.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in an integrated code review system, the system described is provided as an example and not a limitation. As those skilled in the art will appreciate, the present examples are suitable for application in a variety of different types of integrated code review systems.

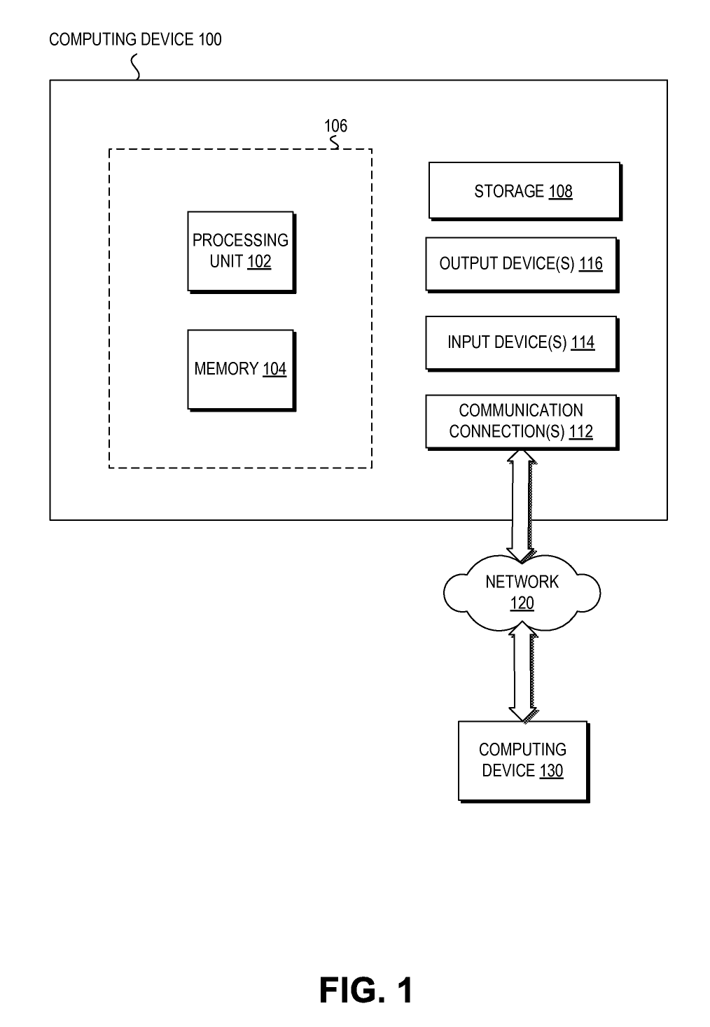

FIG. 1 and the following discussion are intended to provide a brief, general description of a suitable computing environment to implement embodiments of the invention. The operating environment of FIG. 1 is only one example of a suitable operating environment and is not intended to suggest any limitation as to the scope of use or functionality of the operating environment. Other well known computing devices, environments, and/or configurations that may be suitable for use with embodiments described herein include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments of the invention will be described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 1 shows an example of a computing device 100 for implementing one or more embodiments of the invention. In one configuration, computing device 100 includes at least one processing unit 102 and memory 104. Depending on the exact configuration and type of computing device, memory 104 may be volatile (such as RAM), non-volatile (such as ROM, flash memory, etc.) or some combination of the two. This configuration is illustrated in FIG. 1 by dashed line 106.

In other embodiments, device 100 may include additional features and/or functionality. For example, device 100 may also include additional storage (e.g., removable and/or non-removable) including, but not limited to, magnetic storage, optical storage, and the like. Such additional storage is illustrated in FIG. 1 by storage 108. In one embodiment, computer readable instructions to implement embodiments of the invention may be stored in storage 108. Storage 108 may also store other computer readable instructions to implement an operating system, an application program, and the like.

The term “computer readable media” as used herein includes computer storage media. Computer storage media includes volatile and nonvolatile, removable and non-removable media implemented in any method or technology for storage of information such as computer readable instructions or other data. Memory 104 and storage 108 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 100. Any such computer storage media may be part of device 100.

Device 100 may also include communication connection(s) 112 that allow device 100 to communicate with other devices. Communication connection(s) 112 may include, but is not limited to, a modem, a Network Interface Card (NIC), or other interfaces for connecting computing device 100 to other computing devices. Communication connection(s) 112 may include a wired connection or a wireless connection. Communication connection(s) 112 may transmit and/or receive communication media.

Communication media typically embodies computer readable instructions or other data in a “modulated data signal” such as a carrier wave or other transport mechanism and includes any information delivery media. The term “computer readable media” may include communication media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media.

Device 100 may include input device(s) 114 such as keyboard, mouse, pen, voice input device, touch input device, infra-red cameras, video input devices, and/or any other input device. Output device(s) 116 such as one or more displays, speakers, printers, and/or any other output device may also be included in device 100. Input device(s) 114 and output device(s) 116 may be connected to device 100 via a wired connection, wireless connection, or any combination thereof. In one embodiment, an input device or an output device from another computing device may be used as input device(s) 114 or output device(s) 116 for computing device 100.

Components of computing device 100 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 100 may be interconnected by a network. For example, memory 104 may be comprised of multiple physical memory units located in different physical locations interconnected by a network.

Those skilled in the art will realize that storage devices utilized to store computer readable instructions may be distributed across a network. For example, a computing device 130 accessible via network 120 may store computer readable instructions to implement one or more embodiments of the invention. Computing device 100 may access computing device 130 and download a part or all of the computer readable instructions for execution. Alternatively, computing device 100 may download pieces of the computer readable instructions, as needed, or some instructions may be executed at computing device 100 and some at computing device 130. Those skilled in the art will also realize that all or a portion of the computer readable instructions may be carried out by a dedicated circuit, such as a Digital Signal Processor (DSP), programmable logic array, and the like.

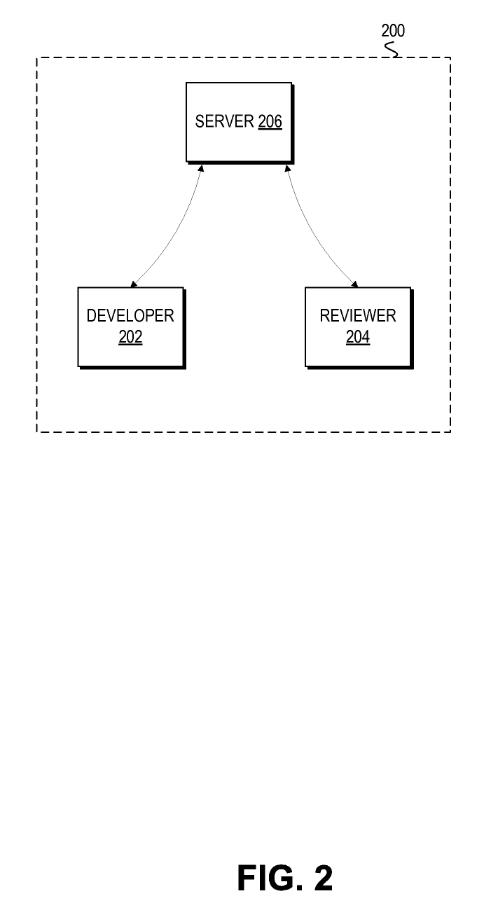

FIG. 2 shows an example system for implementing one or more embodiments of an integrated code review tool system 200. The integrated code review tool system includes a developer node 202, a reviewer node 204, and a server node 206. Each of the developer node 202, the reviewer node 204, or the server node 206 may be implemented by the example computing device 100 of FIG. 1. The developer node 202 is communicatively coupled to the server node 206. The server node 206 is in turn communicatively coupled to the reviewer node 204.

While each of the developer node 202, reviewer node 204, and server node 206 are illustrated as individual entities, it is to be appreciated that the developer node 202, reviewer node 204, and server node 206 may be implemented on any number of example computing devices 100 of FIG. 1. For example, the developer node 202 and the server node 206 may be processes executing on a single example computing device 100 of FIG. 1.

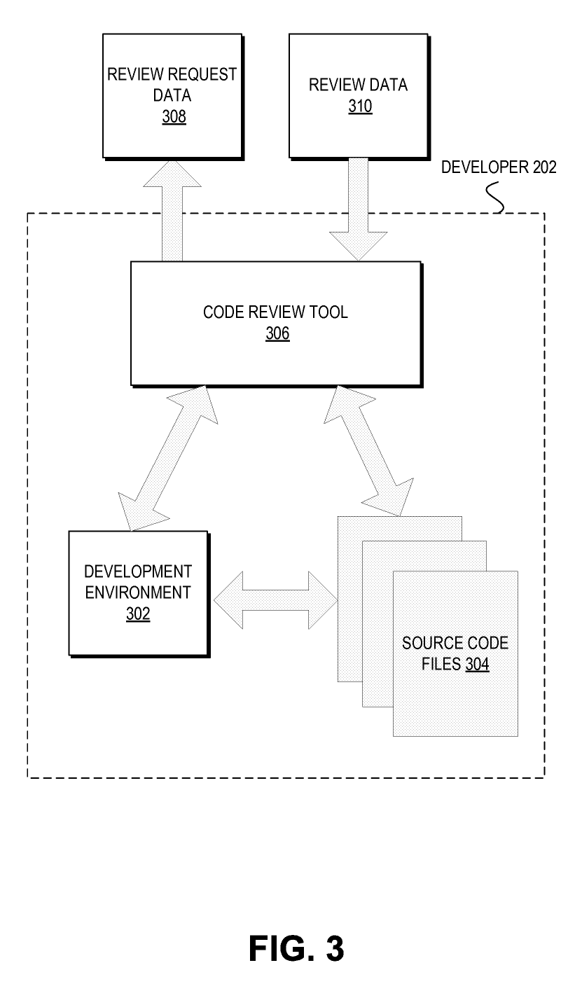

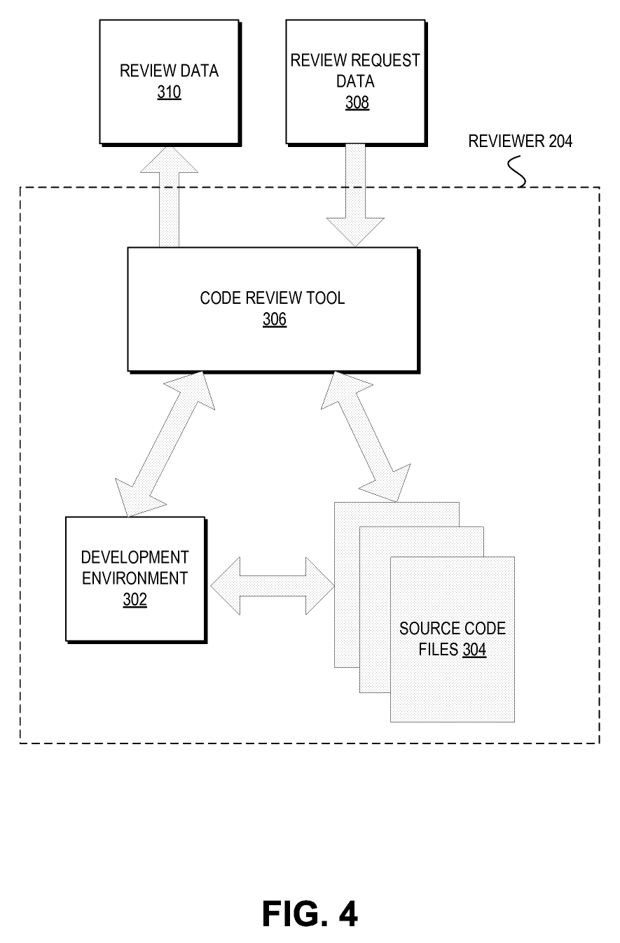

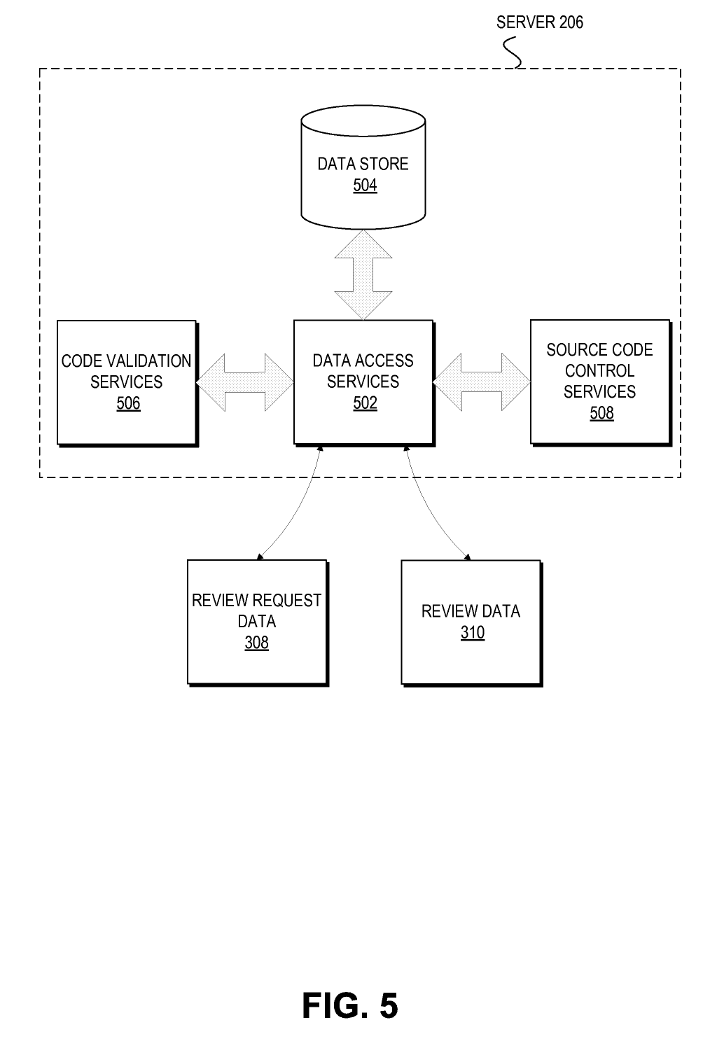

The developer node 202 includes functionality to produce source code, send source code for review using an integrated code review tool, and receive the results of a source code review. The developer node 202 will be discussed in more detail in the discussion of FIG. 3. The server node 206 includes functionality to receive, store, and send information and/or data related to a code review including context information as well perform other functions such as notification by email and other methods. The server node 206 will be discussed more fully in the discussion of FIG. 5. The reviewer node 204 includes functionality to produce code review comments, proposed source code changes, as well as context information indicating a location in the source code to which the comments and proposed source code changes apply using the integrated code review tool. The reviewer node 204 will be discussed in more detail in the discussion of FIG. 4.

FIG. 3 shows an example of a developer node 202 (from FIG. 2) included in one or more embodiments of an integrated code review tool system 200 (from FIG. 2). The developer node 202 includes an integrated development environment 302, one or more source code files 304, and an integrated code review tool 306. The integrated code review tool 306 may send review request data 308 and receive review data 310.

A developer on the developer node 202 may use the integrated development environment 302 to create the source code files 304 or to make changes in the source code files 304. The integrated development environment 302 may be any type of development environment including functionality allowing the developer to create the source code files 304 or to make changes to the source code files 304. For example, the integrated development environment 302 may be Microsoft Visual Studio®, Eclipse, or the like. However, it should be appreciated that any text editor may be used to create the source code files 304.

The source code files 304 may be written using any programming language; for example, the source code files 304 may be written in the C++ language, the C# language, the Java language, or the like. Once a developer on the developer node 202 has created the source code files 304 using the integrated development environment 302, the developer may then utilize the code review tool 206 to create and send the review request data 308 to begin the code review process.

The code review tool 306 can be configured to execute any source code verification and/or validation tools such as review code validation services 206. Such source code verification and/or validation tools may inspect the changes made to the source code by the developer and then present a report to the developer. In an alternative example, such source code verification and/or validation tools may perform a validation of standard and common programming error. In another alternative example, an administrator may configure the code review tool 306 with a policy enforcing one or more rules with respect to the source code review. For example, a policy may prevent the developer from creating a new review request in the event the review code validation services 206 have reported failure on the source code files under review.

The review request data 308 includes, in part, the source code files 304 that are to be reviewed. The source code files 206 may be included in a data package; for example, the source code files 206 may be compiled into a compressed archive file or any other type of compiled file. The review request data 308 also includes an identifier of one or more reviewers that will be requested to review the source code files 206. Such an identifier may be an email address, a network login ID, or the like. The review request data 308 optionally includes one or more text strings including comments from the developer on the developer node 202 intended for the reviewer on the reviewer node 204 (from FIG. 2). In an alternative example, the review data 310 is a set of metadata associated with the review request such that an administrator may extend the metadata to include data containers for any data related to the code review process.

Once the developer has sent the review request data 308, the reviewer on the reviewer node 204 reviews the code and returns the review data 310 to the developer 202. The review data 310 will be discussed in more detail in the discussion of FIG. 4, however, for the purposes of discussion it should be appreciated that the review data 310 includes information intended to communicate proposed changes to the source code files 304, comments, and context information identifying a location in the source code files 304 associated with the appropriate comment and/or proposed changes to the source code files. Such context information may include a file name, a function name, a line number, or the like, any or all of which may be included in the source code files 304.

The developer on the developer node 202 may be notified that the reviewer on the reviewer node 204 has completed the review. The developer on the developer node 202 may then utilize the integrated code review tool 306 to view the review data 310. As previously discussed, the review data 310 may include comments and/or proposed source code changes with context information associating the comment and/or proposed source code changes with a location in the source code files 304. The developer on the developer node 306 may use the integrated code review tool 306 to view the comments and be directed to the location in the source code files 304 to which the comment pertains. The developer on the developer node 202 may then choose to accept or reject the instructions or suggestion provided by the reviewer on the reviewer node 204 in the comment.

Similarly, the developer may use the integrated code review tool 306 to view the changes to the source code files 304 proposed by the reviewer on the reviewer node 204 as received in the review data 310. The changes may be detected by comparing the difference between the source code files 304 sent by the developer on the developer node 202 as part of the review request data 308 and the source code files received as part of the review data 310. Such differences may be presented in a visually distinct manner such as showing a first line from the original file in one color and a changed second line from a second file in a different color. As already discussed, the review data 310 includes context information to associate comments from the reviewer on the reviewer node 204 with the proposed changes and therefore the developer on the developer node 202 may immediately see the comments in context with the proposed change.

The developer may either decide to make the changes to the source code files 304 as proposed by the reviewer on the reviewer node 204, or the developer may decide to reject the changes to the source code. The developer on the developer node 202 may then use the integrated code review tool 306 to indicate whether each of the comments and/or proposed code changes have been accepted or rejected, and may further “commit” the code review, thus preventing the reviewer from making additional comments or proposed changes to the source code files 304.

It is to be appreciated that the integrated code review tool 306 may consume functionality included in the integrated development environment 302. That is, the integrated code review tool 306 may utilize any tools provided by the integrated development environment 302 for real-time syntax checking, compilation, code completion assistance, source code file navigation, and the like. For example, the integrated code review tool 306 may consume Intellisense® functionality from Microsoft Visual Studio®.

FIG. 4 shows an example of a reviewer node 204 (from FIG. 2) included in one or more embodiments of an integrated code review tool system 200 (from FIG. 2). The reviewer node 204 includes an integrated development environment 302, one or more source code files 304, and the integrated code review tool 306. The integrated code review tool 306 may receive review request data 308 and send review data 310. Each of the integrated code review tool 306, integrated development environment 302, source code files 304, review request data 308, and review data 310 have been described in the discussion of FIG. 3 and will not be repeated here. However, it should be appreciated that elements with like numbers function similarly.

Once the developer on the developer node 202 (from FIG. 2) has created and sent the review request data 310, the reviewer on the reviewer node 202 is notified. Such notification may take the form of a balloon tip notification, an email message, an alert received in the integrated code review tool 306, or the like. The reviewer on the reviewer node 204 (from FIG. 2) may then utilize the integrated code review tool 306 or any other application to view and examine the source code files 304 to be reviewed and then create the review data 310. In an alternative example, the integrated code review tool 306 displays extended information regarding the review request data 310 such as the number of source code file that have been changed by the developer on the developer node 202, the number of changed lines in the source code files, and the like. In another alternative example, the integrated code review tool 306 may display the number of reviewers that have already performed a review of the source code, the number of comments associated with the review, and the like.

The review data 310 includes one or more text strings, the one or more text strings including one or more comments. In an alternative example, the review data 310 may further include proposed source code changes to the source code files 304 under review. The integrated code review tool 306 may further provide functionality to display details about the review

Once the reviewer on the reviewer node 204 has completed examination of the source code files 304 included as part of the review request data 308, the reviewer may utilize the integrated code review tool 306 to send the review data 310 to the developer on the developer node 202 (from FIG. 2). In an alternative example, the reviewer may utilize the integrated code review tool 306 to add an indication to the review data 310 that the changes to the source code made by the developer on the developer node 202 may be checked into a source code control system. In another alternative example, the reviewer may utilize the integrated code review tool 306 to add an indication to the review data 310 that the changes to the source code made by the developer on the developer node 202 may not be checked into a source code control system until the developer on the developer node 202 has made an additional change to the source code files and the reviewer has had an opportunity to review the new changes.

As discussed in the description of FIG. 3, it is to be appreciated that the integrated code review tool 306 may consume functionality included in the integrated development environment 302. That is, the integrated code review tool 306 may utilize any tools provided by the integrated development environment 302 for real-time syntax checking, compilation, code completion assistance, and the like. For example, the integrated code review tool 306 may consume Intellisense® functionality from Microsoft Visual Studio®. The reviewer on the reviewer node 204 may make use of such functionality to aid in producing comments or proposed source code changes for the review data 310.

Once the reviewer has sent the review data 310 from the reviewer node 204, the developer on the developer node 202 may inspect the review data 310. As discussed previously, the developer on the developer node 202 may either accept or reject the reviewer's comments and/or proposed code changes included in the review data 310. Such acceptance or rejection may be communicated to the reviewer on the review node 204 through email, through the integrated code review tool 306, or the like. Furthermore, the developer on the developer node 202 may have committed or finalized the code review using the integrated code review tool 306 or any other method and the reviewer may receive an indication of such commitment or finalization through email, the integrated code review tool 306, or the like. In an alternative example, the developer on the developer node 202 may commit or finalize the code review only if the reviewer on the reviewer node 204 has indicated that the review is complete.

FIG. 5 shows an example of a server node 206 (from FIG. 2) included in one or more embodiments of an integrated code review tool system 200 (from FIG. 2). The server node 206 includes data access services 502, code validation services 506, source code control services 508, and a data store 504. The data access services 502 are communicatively coupled to the code validation services 506, the data store 504, and the source code control services 508. The data access services 502 may receive and send each of the review data 310 (from FIG. 3) and the review request data 308 (from FIG. 3). Each of the review data 310 and the review request data 308 have been discussed in the description of FIG. 3 and FIG. 4 and will not be discussed again.

The server node 206 acts as data storage for the data included in the review data 310 and the review request data 308. The server node 206 executes data access services 502 to receive data, store data, respond to requests for access to data stored in the data store 504, send notifications, and finalize or commit any data related to a specific code review. Such data access services 502 may be network services, data access services, and any other executable services. For example, the data access services 502 may be an instance of SQL Server™ and Microsoft .Net Framework™ services such as ADO.Net.

The server node 206 may further execute source code control services 508. Such source code control services 508 may include source code file management, source code file check in, source code check out, source coded versioning, and the like. The server node 206 may also execute code validation services 206. Such code validation services may automatically examine source code files for syntax errors, common programming errors such as buffer overflows, race conditions, memory leaks, and the like. In alternative examples, code validation services 206 may be any type of code validation tool and may be controlled and configured by an administrator. In such an example, the administrator configures the code validation tool such that the code validation tool may prevent the developer from initiating a review request. For example, a tool like prefast can be configured to be mandatory in which case developer must get success result from that tool before s/he can proceed to creating a new review request.

Once the developer on the developer node 202 (from FIG. 2) has created and sent the review request data 308, it is received on the server node 206 by the data access services 502. The data access services may parse the review request data to extract any included source code files to be reviewed, any comments included as text strings, and any identifiers of reviewers. The data access services 502 may then utilize functionality in the code validation services 506 to validate the source code files. Any errors or issues discovered may then be sent back to the developer on the developer node 202.

The data access services 502 then stores any or all data included in the review request data 308 in the data store 504. Once any or all of the data included in the review request data 308 has been stored in the data store 504, the data access services 502 may send a notification to any reviewers whose identifiers were included in the review request data 308. Such a notification may be made through email or any other method. In an alternative example, the data access services 502 may automatically update a bug tracking database or service if the change made to the source code files were made with respect to fixing an error or deficiency in the source code files.

Once the reviewer on the reviewer node 204 (from FIG. 2) has been notified of the review, the reviewer may perform the review and send the review data 310 to the server node 206. As discussed earlier, such review data may include proposed changes to the source code files under review, text strings including comments related to the source code files under review, and context information associating the comments with context information identifying a location in the source code files.

Once the review data 310 has been received by the server node 206, the server node 206 may parse the review data 310 and store any or all of the review data 310 in the data store 504. Once any or all of the review data 310 has been stored in the data store 504, the data access services 502 may send a notification to the developer on the developer node 202 indicating the reviewer has completed the review. The data access services 502 may then send the review data 310 to the developer on the developer node 202.

Once the developer on the developer node 202 has received the review data 310, the developer may accept or reject any or all comment and/or proposed code changes included in the review data 310. The developer on the developer node 202 may further connect to the data access services 502 to commit or finalize the code review process. It is to be appreciated that the developer, the reviewer, or any other process may commit or finalize the code review.

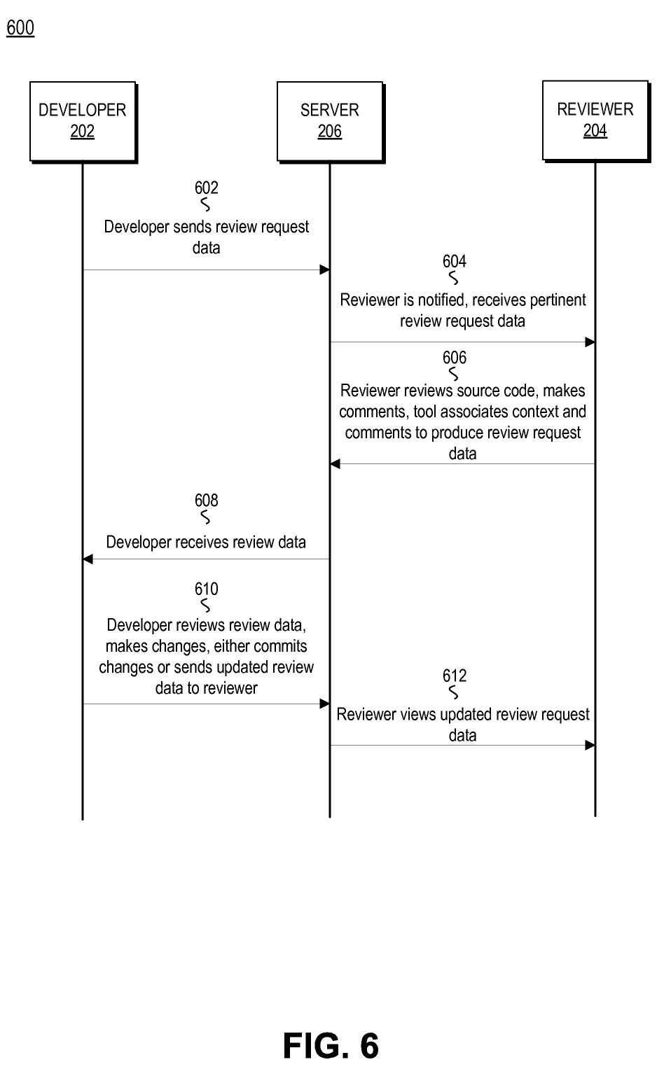

FIG. 6 shows a flow diagram of an example code review method 600. To begin the code review, the developer on the developer node 202 (from FIG. 2) utilizes a code review tool to send 602 the review request data. The review request data may include one or more source code files either individually, in an archive, or the like, text strings including comments, and a list of identifiers of one or more reviewers. Such identifiers may be email addresses, network login ID's, or the like. The review request data is received at the server node 206, and the server node 206 may parse the review request data and store any or all of the review request data. The server node 206 may also perform validation of the source code. For example, the server node 206 may automatically run static analysis tools to verify code against standard flaws such as buffer overruns, memory leaks, and the like.

Next, a reviewer on the reviewer node 204 is notified 604 of the pending code review and receives the review request data. Such a notification may be received in email, in a code review application, or the like. It is to be appreciated that not all of the review request data will be sent to the reviewer; rather, only the information necessary for the reviewer to perform the code review may be sent. The review request data typically includes one or more source code files to be reviewed and text strings associated with the one or more source code files include comments from the developer.

The reviewer on the reviewer node 204 then begins reviewing 606 the source code files for any flaws, errors, or the like. The reviewer utilizes the code review tool to make any comments and/or proposed code changes to the source code files. The review tool automatically creates context information to associate the reviewer comments and/or proposed code changes with the location in the source code file to which the comment pertains. Such context information may include any or all of a source code file name, a function name, a line number, or the like. Once the reviewer has completed reviewing the source code files, the reviewer utilizes the code review tool to send the review data to the server node 206. Such review data may include any or all proposed code changes, text strings including comments, and context information associating the text strings with a location in source code files.

Once the server node 206 receives the review data, the server node 206 parses the review data and stores any or all of the review data. The server node 206 then sends a notification to the developer on the developer node 202 indicating that the reviewer on the reviewer node 204 has submitted the review data. Such a notification may be made through email, though the code review tool, or the like.

The developer on the developer node 202 may then receive 608 the review data. The developer may then utilize the code review tool to review 610 the text string comments of the reviewer. The code review tool parses the context information to display the reviewer's comments in line with the source code such that the developer may see the reviewer's comments in context with the code to which the comments apply. Such functionality may be provided through a user interface in which the developer may click or double click on a comment and be presented with the exact location in the source code file to which the comment is directed. The developer may also view any proposed code changes sent by the reviewer.

Once the developer has reviewed all of the review data, the developer may accept or reject any or all of the comments or proposed changes using the code review tool. If the developer decides to accept a reviewer's proposed code changes or makes a change to the source files in response to a comment from the reviewer, the developer may further submit updated review request data to the server node 206.

The server node 206 may then notify and/or send 612 the updated review request data to the reviewer on the reviewer node 204. The reviewer may then utilize the code review tool to view any or all changes to the source code by the developer and any text strings including comments sent by the developer.

It is to be appreciated that the review method 600 may be committed or finalized at any point after the reviewer has sent 610 the updated review request data indicating the status of any or all of the proposed source code changes and/or comments sent by the reviewer. In addition, the review method 600 may be committed or finalized by any process acting on the developer's behalf or the reviewer's behalf.

1. A method, comprising:
receiving a first set of data including information associated with source code to be reviewed;
associating context information with a second set of data associated with a source code review, the context information identifying a location in the source code; and
storing the context information and the second set of data.

2. The method of claim 1, wherein the second set of data is a text string including a comment from a reviewer.

3. The method of claim 1, wherein the second set of data includes a proposed change to the source code.

4. The method of claim 1, further comprising:
receiving at least one text string, the text string including a comment from the developer of the source code.

5. The method of claim 1, further comprising preventing the first set of data from being received in response to an indication that the source code includes an error or deficiency.

6. The method of claim 1, wherein the context information includes a file name.

7. The method of claim 1, wherein the context information includes a function name.

8. The method of claim 1, wherein the context information includes a line number.

9. One or more device-readable media having device-executable instructions for performing steps comprising:
sending a first set of data including information associated with source code to be reviewed; and
receiving context information correlating a location in the source code with a second set of data associated with a review of the source code.

10. The one or more device-readable media of claim 9, wherein the first set of data comprises a data package including a least one source code file.

11. The one or more device-readable media of claim 10, wherein the first set of data includes at least an identifier of a reviewer.

12. The one or more device-readable media of claim 10, wherein the set of data includes a text string.

13. The one or more device-readable media of claim 10, further comprising:
receiving a notification that the review of the source code is complete.

14. The one or more device-readable media of claim 10, further comprising:
sending a second set of data including information associated with a change made to the source code as a result of the review of the source code.

15. The one or more device-readable media of claim 10, further comprising:
displaying the location of the source code associated with the context information.

16. The one or more device-readable media of claim 10, wherein the sending further comprises:
executing one or more validation operations on the source code.

17. The one or more device-readable media of claim 16, wherein the sending further comprises:
including the results of the one or more validation operations in the first set of data.

18. A code review system, comprising:
a developer node, for storing developer data associated with a source code review at central location and for receiving reviewer data associated with the source code review, the reviewer data including context information correlating the reviewer data to a location within the source code; and
a reviewer node, for receiving the developer data and for sending the reviewer data, the reviewer for creating the context information.

19. The code review system of claim 18, wherein the central location is for updating a bug database.

20. The code review system of claim 18, further comprising an administrator for creating at least one policy associated with a source code review.
